(19) United States
(12) Patent Application Publication
(10) Pub. No.: US 2007/0251914 A1
(43) Pub. Date: Nov. 1, 2007

(54) Glass thinning equipment and manufacturing method

(75) Inventor: Shintaro Yanagisawa, Saitama (JP)

Correspondence Address: BACON & THOMAS, PLLC, 625 SLATERS LANE, FOURTH FLOOR, ALEXANDRIA, VA, 22314, US

(73) Assignee: Tim Tsai, Princeton, TX (US)

(21) Appl. No.: 11/580,125

(22) Filed: Oct. 13, 2006

(30) Foreign Application Priority Data
Apr. 27, 2006 (CN) 200610079901.X

(51) Int. Cl. B29D 11/00; C23F 1/00

(52) U.S. Cl. 216/24; 156/345.17

(57) ABSTRACT

PROBLEM TO BE SOLVED:

To provide a practical technology for enabling thickness reduction of an FPD.

SOLUTION:

Electrodes 11 are formed on one of a pair of glass substrates 1 and the glass substrates 1 are laminated via a sealing material 12. Thereafter, an external surface thinning process which reduces the thickness of external surfaces of the glass substrates 1 is performed. During said thinning process, an eluate L composed of hydrofluoric acid is sprayed from nozzles 4 toward the external surfaces of the glass substrates 1 by pressure within a range from 0.5 to 3.5 kg/cm2 under an acceleration larger than the acceleration caused by its own weight. The external surfaces are impacted by the eluate L for the purpose of thinning through the physical action caused by the impact and the chemical reaction of the eluate L.

### FIELD OF THE INVENTION

This invention relates to manufacture of flat-panel display (referred to as FPD hereinafter), such as a liquid crystal display, a plasma display, or an organic electroluminescence (EL) display.

### BACKGROUND OF THE INVENTION

FPD, such as a liquid crystal display or a plasma display, is widely used in various electronic devices, such as display for computer monitor, TV display, or display portion for cellular phone. Recently, an organic EL display of high-speed response that features self-luminescence without back light has been developed, and are highly expected in the future.

One of the technical problems for such FPD is thinning. Thinning of FPD is demanded with thinning, miniaturization and lightweight of the electronic device in which the FPD is provided. For example, the demand for a thinner or smaller notebook computer or a thinner or smaller cellular phone results in the demand for a thinner or smaller FPD.

An important factor for thinning or miniaturizing of FPD is related to the glass substrate. A structure in which a pair of substrates is laminated and component electrodes are arranged on the inner surfaces of the substrates is provided, no matter for a liquid crystal display, a plasma display, or an organic EL display. A certain degree of thickness for the glass is needed due to the high specific gravity of glasses and the requirement for ensuring mechanical strength of the glass. Therefore, the thinning or miniaturizing of FPD is impeded by the glass substrate.

In various processes of manufacturing FPD, a method of producing a plurality of FPD from a pair of glass substrates with large size is employed. A pair of glass substrates is separated into areas to produce the FPD, wherein component electrodes are respectively formed on each area. After processes, such as lamination, are completed, a pair of glass substrates is cut into the areas, and then a process of finishing proceeds.

The method of producing a plurality of FPD from a pair of glass substrates has a merit of reducing manufacturing cost due to the simplification of processes; it tends to require the glass substrates big. For example, in the manufacture process of a liquid crystal display, a glass substrate of about 2000 mm×1800 mm is used. When dealing with such a big glass substrate, if it is thin, or the glass substrate might be bent due to its weight, the glass substrate is easily broken. Therefore, a certain degree of glass substrate thickness is necessary.

On the other hand, even if the glass substrate is thinned to a certain degree, the elements after being cut into areas (half-finished products) or the finished products will cause no problem because they are small in size. In this respect, the invention of JP 5-249422, employs a method of etching the external surface of one glass substrate for thinning and then cutting the glass substrate into areas, after laminating a pair of glass substrates.

[Patent reference 1] JP 5-249422

### DESCRIPTION OF THE INVENTION

### Problem(s) to be Solved by the Invention

In the above-mentioned reference, the etching is carried out by a dipping method of for a leaching solution. However, more specifically, by way of the research of the inventor of the present invention, with respect to the characteristic of planarity which is an important factor for FPD, the sufficient quality is not guaranteed in said etching method. This issue is explained as follows.

In the above-mentioned reference, there is no concrete explanation about the etchant used in this regard, based on the information disclosed in the dipping method. By way of the research of the inventor of the present invention, hydrofluoric acid is considered to be used as the etchant. However, more specifically, it is difficult to perform the etching that can guarantee the planarity required by the FPD by simply dipping the glass substrate into the hydrofluoric acid.

After dipping the glass substrate into the hydrofluoric acid, the surface of the glass reacts with the hydrofluoric acid, thereby slowly softening and dissolving it. With respect to planarizing the etched surface, it is necessary to uniformly supply fresh (un-reacted) etchant which is replaced by the etchant after reaction. However, it is difficult for the dipping method. It is necessary to get rid of the softened glass material by the reaction with the etchant and then supply fresh etchant to the lower layer. Since it is difficult to uniformly etch out the softened and dissolved glass material, the surface planarity after etching is not good.

It is unavoidable for the glass substrate to have irregularities since the constitution or the crystallized state of the glass substrate is not completely uniform. When the dipping method is used for etching, it is easily affected by the constitution or the irregularity since only the chemical reaction functions. That is, un-etched traces are left in the case of the constitution or crystal state in which there are locations difficult to etch, thus uneven etching amount is generated. In this regard, the planarity is degraded by the dipping method. Thus the etching by the above-mentioned dipping method is not suitable for practical use.

The present invention is made in order to solve this technical problem, so that the technical meaning of offering the practical technique which enables thinning of FPD is achieved.

### MEANS FOR SOLVING THE PROBLEM

In order to solve the above-mentioned technical problems, the present invention according to claim 1 discloses a method of manufacturing flat-panel displays, comprising: an electrodes formation process which forms electrodes on at least one of a pair of substrates, wherein one or both of said pair of substrates are glass substrates; a sealing process which laminates said pair of substrates by a sealing material to seal the interior after said electrodes formation process; and an external surface thinning process which reduces the thickness of external surfaces of the glass substrates (i.e., one or both of said pair of substrates) after said sealing process, wherein, during said thinning process, an eluate which elutes material of said external surfaces of the glass substrates is sprayed toward said external surfaces with an acceleration larger than the acceleration caused by its own weight so that said eluate is sprayed toward said external surfaces and impacts said external surfaces, thereby eluting said external surfaces for thinning purpose through the physical action of the impact caused by said eluate and the chemical reaction of said eluate.

Moreover, in order to solve the above-mentioned technical problem, the present invention according to claim 2 discloses that said eluate is hydrofluoric acid in the configuration of claim 1.

Moreover, in order to solve the above-mentioned technical problem, the present invention according to claim 3 discloses that the impact on said external surfaces by said eluate is within a range of 0.5 kg/cm²-3.5 kg/cm², in the configuration of claim 1 or claim 2.

Moreover, in order to solve the above-mentioned technical problem, the present invention according to claim 4 discloses that said substrates are held so that said external surfaces are in a perpendicular incident posture during the spraying of said eluate, in the configuration of any one of claims 1 to 3.

Moreover, in order to solve the above-mentioned technical problem, the present invention according to claim 5 discloses that external surfaces of both of said pair of substrates after said lamination are thinned concurrently so that the whole thickness is reduced, in the configuration of any one of claims 1 to 4.

Moreover, in order to solve the above-mentioned technical problem, the present invention according to claim 6 discloses that said eluate is sprayed through injection holes of nozzles, and the distances from the injection holes of the nozzles at the beginning of the thinning to said external surfaces of the substrates are within a range of 5 mm to 100 mm, in the configuration of any one of claims 1 to 5.

Moreover, in order to solve the above-mentioned technical problem, the present invention according to claim 7 discloses that said eluate is sprayed through injection holes of nozzles, said injection holes are arranged with equal intervals, and the distance from each of said injection holes to said external surfaces is fixed, in the configuration of any one of claims 1 to 5.

Moreover, in order to solve the above-mentioned technical problem, the present invention according to claim 8 discloses a surface thinning device for thinning external surfaces of glass substrates of flat-panel displays (FPD), comprising a processing chamber in which the thinning of external surfaces is processed; a substrate holder for holding said glass substrates to a predetermined location in said processing chamber; nozzles having injection holes for spraying an eluate toward said external surfaces of the glass substrates held by said substrate holder; and an eluate supply system for supplying the eluate to the nozzles, said eluate supply system supplies the eluate to the nozzles so that the eluate is sprayed toward and impacts said external surfaces with an acceleration larger than the acceleration caused by its own weight, thereby eluting said external surfaces for thinning purpose through the physical action of the impact caused by said eluate and the chemical reaction of said eluate.

Moreover, in order to solve the above-mentioned technical problem, the present invention according to claim 9 discloses that said eluate is hydrofluoric acid in the configuration of claim 8.

Moreover, in order to solve the above-mentioned technical problem, the present invention according to claim 10 discloses that said eluate supply system forces said eluate to be sprayed from said injection holes of said nozzles to impact said external surfaces of said glass substrates with a pressure within a range of 0.5 kg/cm²-3.5 kg/cm², in the configuration of claims 8 or 9.

Moreover, in order to solve the above-mentioned technical problem, the present invention according to claim 11 discloses that said substrate holder holds said substrates so that said external surfaces are in a perpendicular incident posture during the spraying of said eluate, in the configuration of any one of claims 8 to 10.

Moreover, in order to solve the above-mentioned technical problem, the present invention according to claim 12 discloses that said nozzles are arranged for both of said pair of glass substrates held by said substrate holder so that the external surfaces of both of said pair of glass substrates after said lamination are thinned concurrently, in the configuration of any one of claims 8 to 11.

Moreover, in order to solve the above-mentioned technical problem, the present invention according to claim 13 discloses that the distances from said injection holes of said nozzles at the beginning of the thinning to said external surfaces of said glass substrates are within a range of 5 mm to 100 mm, in the configuration of any one of claims 8 to 12.

Moreover, in order to solve the above-mentioned technical problem, the present invention according to claim 14 discloses that said injection holes are arranged with equal intervals, and the distance from each of said injection holes to said external surfaces is fixed, in the configuration of any one of claims 8 to 12.

Moreover, in order to solve the above-mentioned technical problem, the present invention according to claim 15 discloses a flat-panel display formed with a light-transmitting control portion or light-emitting portion inside a pair of glass substrates after lamination, characterized in that an eluate is sprayed toward both external surfaces of said pair of glass substrates with an acceleration larger than the acceleration caused by its own weight so that said eluate performs thinning operation by a way of spraying and impacting, and obtains a planarity where its maximum roughness is 0.1 μm or less.

### EFFECT OF THE INVENTION

According to claim 1 or claim 8 of this application, in addition to supplying fresh (without eluting the material of the external surfaces) eluate, the eluate eluted with the material of the external surfaces also continuously flows out due to the impact, thus the thinning of excellent efficiency and uniformity is achieved. Even in case that the glass constitution or the crystallized state of the external surfaces is not uniform, the thinning could be performed sufficiently uniform since the physical action is incorporated. Therefore, the planarity of the external surfaces after thinning could be enhanced, thereby improving the display performance of the produced FPD.

Moreover, according to claim 3 or claim 10 of this application, in addition to the above effect, fresh eluate is sufficiently supplied since the impact on said external surfaces by said eluate is within a range of 0.5 kg/cm²-3.5 kg/cm². Besides, since the physical action is sufficiently employed, the thinning is satisfactorily performed even in case that the glass constitution or the crystallized state of the external surfaces is not uniform, thereby ensuring better planarity.

Moreover, according to claim 4 or claim 11 of this application, in addition to the above effects, the effect of facilitating the permutation of the eluate of the external surfaces is achieved since the external surfaces are in a perpendicular incident posture, thereby sufficiently and efficiently performing the thinning of the external surfaces.

Moreover, according to claim 5 or claim 12 of this application, in addition to the above effects, the whole thickness is reduced since the external surfaces of both of said pair of substrates after lamination is thinned concurrently, thereby improving productivity in addition to facilitating the thinning of laminated panels.

Moreover, according to claim 6 or claim 13 of this application, in addition to the above effects, the uniformity of impact is ensured since the distances from the injection holes of the nozzles at the beginning of the thinning to the external surfaces of the substrates are within a range of 5 mm to 100 mm, thereby achieving a practical process.

Moreover, according to claim 7 or claim 14 of this application, in addition to the above effects, the uniformity of impact pressure caused by the sprayed eluate is easily achieved since said injection holes are arranged with equal intervals and the distance from each of said injection holes to said external surfaces is fixed, thereby facilitating the planarity of the thinning process.

Moreover, according to claim 15 of this application, the thinning and lightweight of the assembled electronic products are facilitated since the thinned FPD are provided, thereby providing products of less defects and better performance due to the enhanced planarity.

### BRIEF DESCRIPTION OF THE DRAWINGS

FIG. 1 is a schematic diagram illustrating a manufacturing method of FPD according to an embodiment of the invention.

FIG. 2 is a schematic diagram of an external surface thinning device according to an embodiment of the invention.

FIG. 3 is a sectional diagram of the device shown in FIG. 2.

FIG. 4 is a perspective diagram for the substrate holder 3 of the device shown in FIGS. 2 and 3.

FIG. 5 schematically shows a perspective diagram of the nozzles 4 of FIG. 3.

FIG. 6 is a schematic diagram showing the eluate L that is uniformly sprayed from each injection hole 41 toward the external surfaces of the laminated substrate 10.

FIG. 7 is a cross-section schematic diagram of the FPD according to the embodiment.

### BEST MODE OF CARRYING OUT THE INVENTION

In the following, the best mode (referred to as embodiment hereinafter) for carrying out the invention is explained.

In the following explanation, a liquid crystal display (referred to as LCD hereinafter) is taken as an example of FPD.

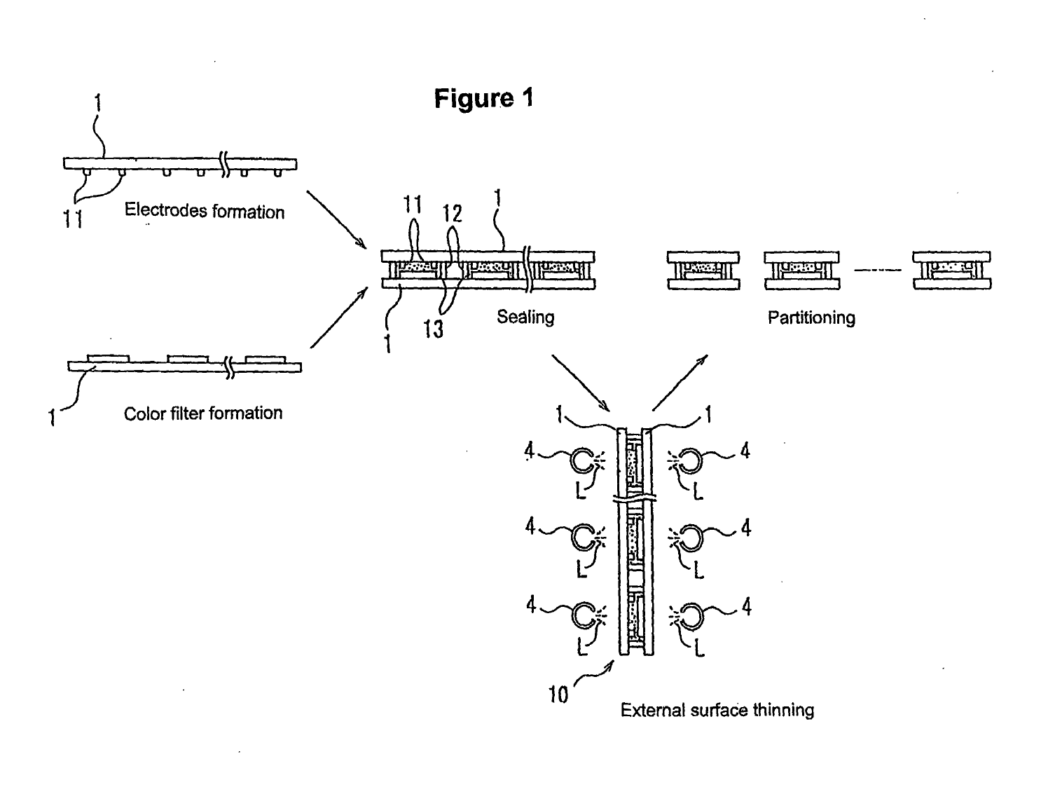

FIG. 1 is a schematic diagram illustrating a manufacturing method of FPD according to an embodiment of the invention. The method of FIG. 1, is a method for manufacturing LCD of, for example, cellular phones. The method of FIG. 1 comprises: an electrodes formation process which forms electrodes 11 on one of a pair of substrates 1, wherein both of the pair of substrates 1 are glass substrates; a sealing process which laminates the pair of substrates 1 by a sealing material 12 after the electrodes formation process, wherein the interior is impregnated with liquid crystal 13; and an external surface thinning process which reduces the thickness of external surfaces of the glass substrates 1 after said sealing process.

In the manufacturing method of FIG. 1, pluralities of LCDs are produced from a pair of glass substrates 1 with almost the same shape and size. The pair of glass substrates 1 is partitioned into areas for the purpose of producing each LCD, and the processes such as the electrodes formation process are performed with respect to each area.

The electrodes formation process comprises: a transparent electrodes formation process which forms a transparent conductive film such as ITO; and a driving electrode or common electrodes formation process which forms a low-temperature polycrystalline silicon film by plasma CVD. A photolithography process consists of exposure, development, etching, etc. is included in each process.

A color filter formation process is performed with respect to the other side of the glass substrates 1. The color filter formation process is a process which forms the coloring layer, a black matrix, a transparent electrode, etc. on the glass substrate 1. The coloring layer is a process which forms the pigment for a color picture by the predetermined pattern, and is performed by a photolithography method, a printing method, or an electroplating method. The black matrix is a light-shielding film formed along the pixel boundary for improving the contrast or preventing color mixture; and, in many cases, is formed by sputtering. In many cases, the transparent electrode is the ITO film, and is formed by sputtering.

The sealing material 12 is applied to the surface of one of the glass substrates 1 in the sealing process. The sealing material 12 is applied in the shape of a periphery along the profile of each LCD produced. Specified quantity of the liquid crystal 13 is dropped at the inside surrounded by the sealing material 12. Then, spacers are disposed, if needed, so that the other one of the substrates 1 are aligned and laminated to cover with a specific positional relationship.

Next, the external surface thinning process which reduces the large features of external surfaces is performed according to the present embodiment. The thinning process of the present embodiment is performed by spraying an eluate L which elutes the external surfaces of the glass substrates 1 toward the external surfaces, thereby attaching an acceleration larger than the acceleration of gravity caused by its own weight. By utilizing the chemical reaction of the eluate L and the physical action of the spraying, the external surfaces are eluted due to the spraying of the eluate L. Besides, the effect of simply spreading the eluate L would be different since only the acceleration caused by its own weight is attached.

Besides, in the specification, the surfaces of a pair of substrates that face each other are referred to as “internal surfaces”, while their opposite surfaces are referred to as “external surfaces”. The external surface thinning process of the present embodiment is a process that reduces both external surfaces of a pair of laminated glass substrates (referred to as laminated substrate 10 hereinafter).

As shown in FIG. 1, in the present embodiment, the laminated substrate 10 are held upright, and the eluate L is sprayed from nozzles 4 arranged for both sides of the laminated substrate 10. As the eluate L, strong acid such as hydrofluoric acid is used. In the case of hydrofluoric acid, it is diluted to about 10-50% with respect to water. The impact pressure on the external surfaces of the laminated substrates 10 is 0.5 kg/cm²-3.5 kg/cm².

The external surfaces impacted by the eluate L sprayed from the nozzles 4 are eluted by the chemical reaction of the eluate L, and the eluate L flew out due to the impact. Thus the external surfaces are thinned, and the thickness of the substrates 1 (i.e., the whole thickness of the laminated substrate 10) is reduced.

During the thinning process, masking tapes are stuck on the places that should not contact the eluate L, for the protection in advance. As the masking tapes, when the eluate L is strong acid, the acid-proof sheet of fluororesin, such as polypropylene (PP) and Teflon (trademark of Du Pont) is used, wherein an adhesive with a thickness of tens of micrometers is applied on the back thereof. For example, SPV-362M etc. manufactured by NITTO DENKO CORP.

After the above external surface thinning process, a partitioning process is performed after a process of cleaning the external surfaces as necessary. The partitioning process is performed along the outline of each produced LCD so that the laminated substrate 10 is broken.

According to the above manufacturing method of this embodiment, the eluate L which elutes the external surfaces of the glass substrates 1 is sprayed toward the external surfaces, thereby attaching an acceleration larger than the acceleration of gravity caused by its own weight so that the eluate L is sprayed toward the external surfaces and impacts the external surfaces. The thinning process is performed by utilizing the physical action due to the impact caused by the eluate L, as well as the chemical reaction of eluting the external surfaces with the eluate L. Accordingly, in addition to continuously providing new eluate L, the eluate L containing the material of the external surfaces will also continuously flow out due to the impact, thereby achieving a thinning process of excellent efficiency and uniformity. Even in case that the glass constitution or the crystallized state of the external surfaces is not uniform, the thinning process could be performed sufficiently uniform since the physical action is incorporated. Therefore, the planarity of the external surfaces after thinning could be enhanced, thereby improving the display performance of the produced FPD.

Next, an external surface thinning device suitable for the above-mentioned manufacturing method is explained. The following explanation also serves as an explanation of an external surface thinning device according to an embodiment of the invention.

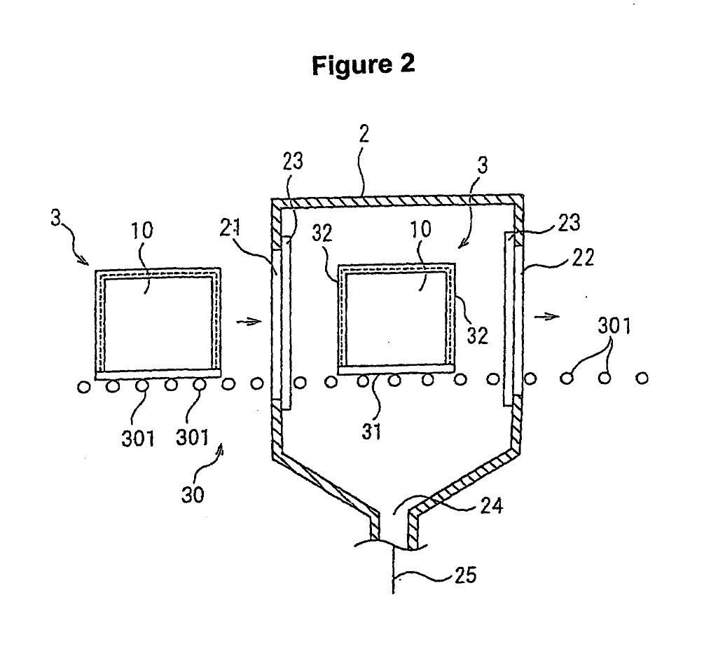

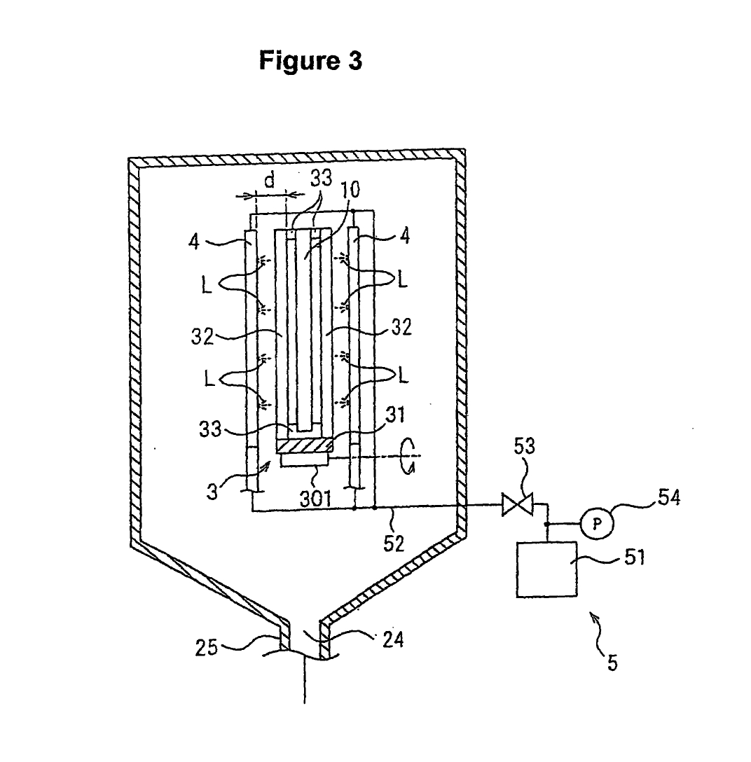

FIG. 2 is a schematic diagram of an external surface thinning device according to an embodiment of the invention. FIG. 3 is a sectional diagram of the device shown in FIG. 2. The external surface thinning device shown in FIGS. 2 and 3 comprises a processing chamber 2 in which the thinning of external surfaces is processed; a substrate holder 3 for holding the glass substrates 1 to a predetermined location in the processing chamber 2; nozzles 4 arranged for spraying the eluate L toward the external surfaces of the glass substrates 1 held by the substrate holder 3; and an eluate supply system 5 for supplying the eluate L to the nozzles 4. In the embodiment, the substrate holder 3 becomes a member of holding the laminated substrate 10 since the etching of the external surfaces is performed after the lamination.

The processing chamber 2 is equipped with a carrying-in opening 21 which carries in the laminated substrate 10, and a taking-out opening 22 which takes out the laminated substrate 10 after the external surface thinning process. The carrying-in opening 21 and the taking-out opening 22 are opened and closed by blockade gates 23. In addition, the opening and closing motions are performed by moving the blockade gates 23 in a horizontal direction (a direction perpendicular to the paper of FIG. 2) perpendicular to the carrying direction.

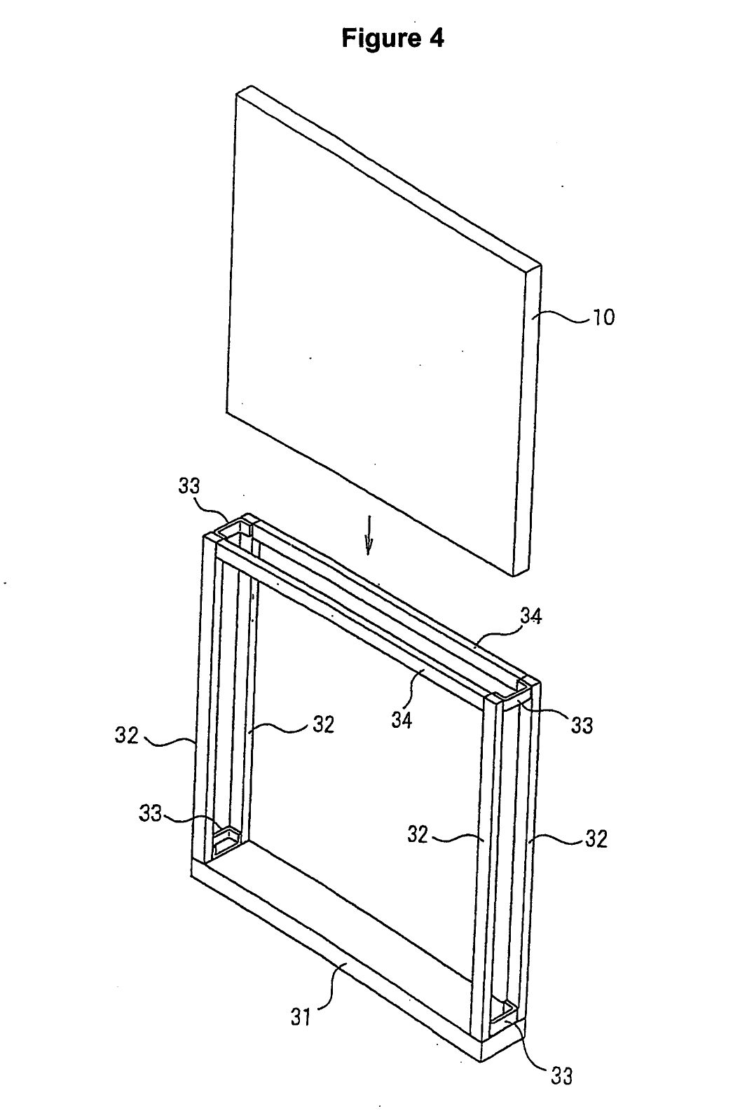

This device is provided with carrying means 30 for carrying the laminated substrate 10 through the carrying-in opening 21 and the taking-out opening 22. The substrate holder 3 is provided as a member constituting the carrying means 30. FIG. 4 is a perspective diagram for the substrate holder 3 of the device shown in FIGS. 2 and 3.

As shown in FIG. 4, the substrate holder 3 is a member which holds the laminated substrate 10 slightly upright. The substrate holder 3 mainly consists of a bottom plate 31 in a horizontal status, pillars 32 arranged upright on the bottom plate 31, and buffer members 33 installed on the pillars 32.

The pillars 32 are arranged on corners of the long and thin bottom plate 31, with a total number of 4. Beam members 34 are further arranged along the long side of the bottom plate 31 to reinforce the substrate holder 3 by connecting the upper ends of the pillars 32. Each pillar 32 is slightly higher than the upright laminated substrate 10. The space between the two pillars 32 on the short side of the bottom plate 31 is slightly bigger than the thickness of the laminated substrate 10. The space between the two pillars 32 on the long side of the bottom plate 31 is slightly longer than the length of the laminated substrate 10. The laminated substrate 10 is held by being inserted into the space formed by these pillars 32.

The buffer members 33 are the members in direct contact with the laminated substrate 10 without abutting the laminated substrate 10. The buffer members 33 are formed by the material that is resistant to the eluate L (chemical-resistant), for example, the fluororesin such as Teflon (trademark of Du Pont).

As shown in FIG. 4, the buffer members 33 are formed by connecting the lower ends of the pillars 32 on both ends of the long side of the bottom plate 31 and connecting the upper ends of the pillars 32 on both ends of the long side. The held laminated substrate 10 is in contact with the corners of these buffer members 33. The cross-section configuration of the lower buffer members 33 contacting the lower corners of the laminated substrate 10 is a concave shape in the short side direction and an L shape in the long side direction. The cross-section configuration of the upper buffer members 33 contacting the upper corners of the laminated substrate 10 is a traverse concave shape in the short side direction. As shown in FIG. 4, when installing, the laminated substrate 10 is inserted from the top and dropped within the concaves of the buffer members 33.

The carrying means 30 consists of, for example, rack-and-pinion means. The carrying means 30 is constituted by engaging the bottom plate 31 which serves as a rack with pinions 301. The pinions 301 are arranged along the carrying line with specific intervals. The pinions 301 are provided at the inside and outside of the processing chamber 2. In addition, guide members which guide the movement of the substrate holder 3 are properly arranged.

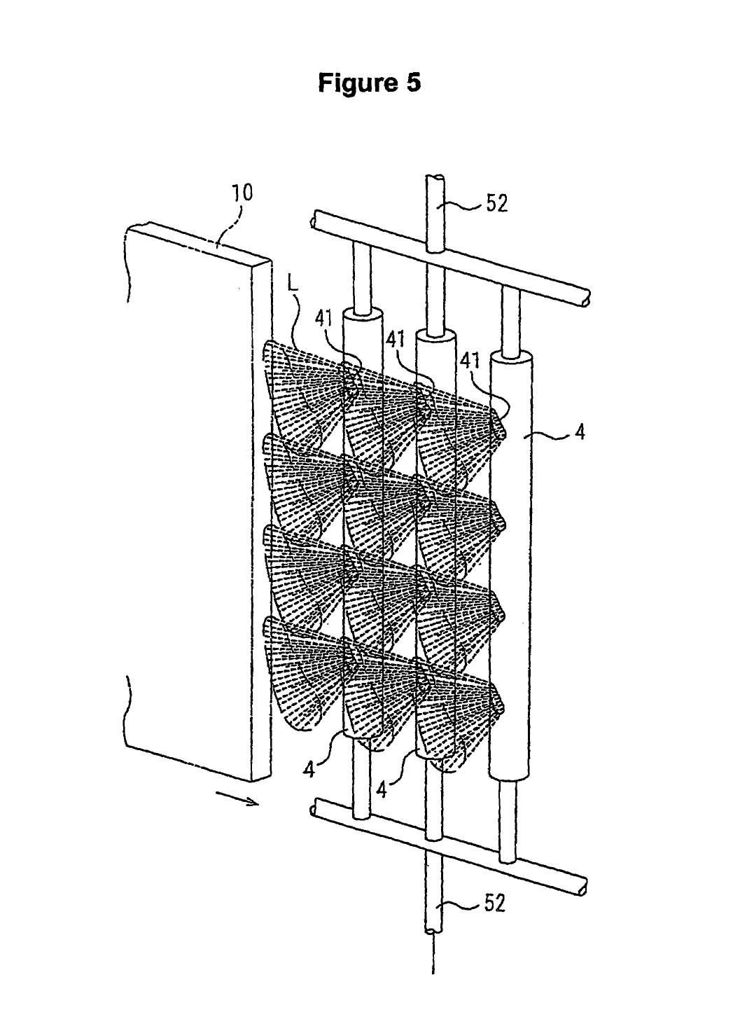

As shown in FIG. 3, the nozzles 4 are arranged near both sides of the laminated substrate 10 held by the substrate holder 3 so that the eluate L can be concurrently sprayed toward the external surfaces of both sides of the laminated substrate 10. FIG. 5 schematically shows a perspective diagram of the nozzles 4 of FIG. 3.

As shown in FIG. 5, the nozzles 4 are tubular members with injection holes 41. As shown in FIG. 5, the nozzles 4 are arranged so that they may extend in the perpendicular direction, and are provided in parallel in the long side direction (carrying direction) of the laminated substrate 10 with uniform intervals. The injection holes 41 are provided on the portions of the nozzles 4 that face the laminated substrate 10 with uniform intervals in the extending direction of the tube (perpendicular direction). Besides, it is possible to provide more (or less) nozzles 4 than those shown in FIG. 5. It is also possible to arrange the nozzles 4 in parallel in the horizontal direction or the slanted direction. Furthermore, the nozzles 4 do not need to be tubular and could be tabular and other configurations.

The eluate supply system 5 consists of a reservoir 51 for storing the eluate L, pipeline 52 for connecting the reservoir 51 and the nozzles 4, a valve 53 provided on the pipeline 52 and a liquid-sending pump 54, etc. A filter for removing impurities, dust, etc. from the eluate L or a pump for pressure regulation is provided, if necessary.

The eluate L is supplied by the eluate supply system 5 to each nozzle 4, and then sprayed from each injection hole 41 toward the external surfaces of the laminated substrate 10 held by the substrate holder 3. The sprayed eluate L will impact and elute the external surfaces for thinning of the external surfaces.

In addition, as shown in FIG. 2, the lower part of the processing chamber 2 is formed as a funnel, and the bottom is provided with a discharge hole 24. An exhaust pipe 25 for discharging the used eluate L is connected to the discharge hole 24. As mentioned above, the eluate L eluted with the material of the laminated substrate 10 will fall to the bottom of the processing chamber 2, and then discharged through the discharge hole 24 and the exhaust pipe 25.

Moreover, the internal wall of the processing chamber 2 or the surfaces of the members inside of the processing chamber 2 are formed with chemical-resistant composition. For example, when the eluate L is hydrofluoric acid, the internal wall or the surfaces of each member will be coated with the fluororesin such as Teflon (trademark of Du Pont). Besides, the eluate L is blocked by the blockade gates 23 of the carrying-in opening 21 and the taking-out opening 22 so as not to leak out.

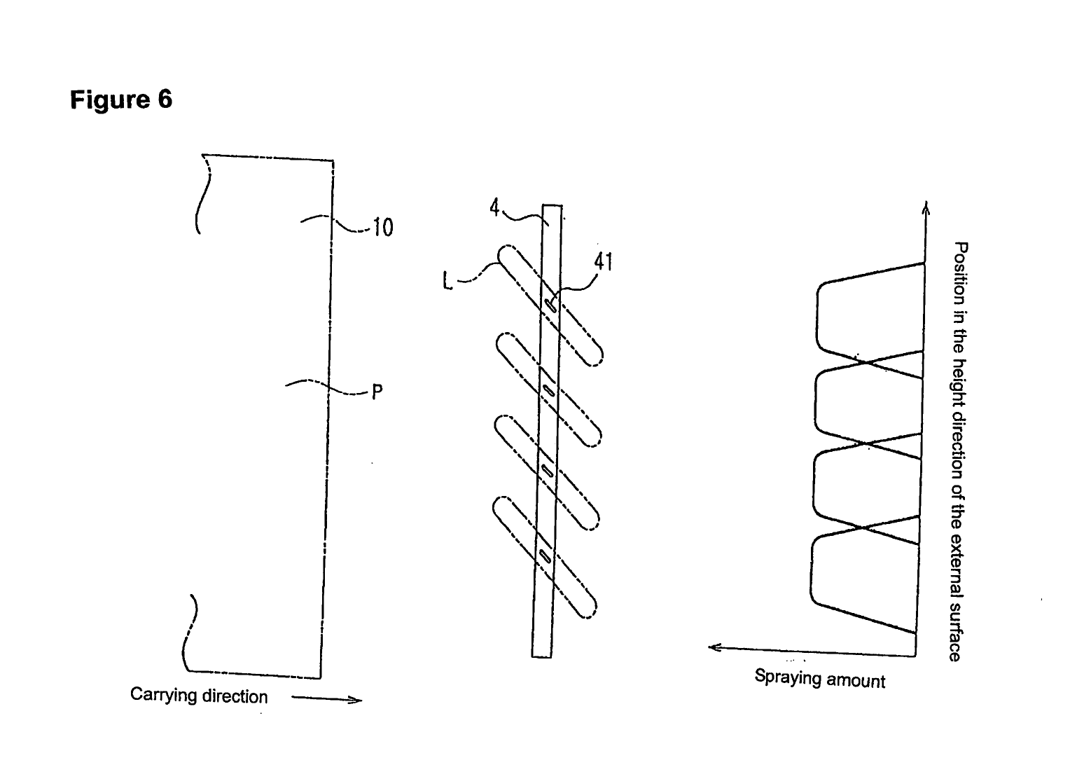

The device according to the present embodiment has put a special effort to the structure of the nozzles 4 in order to enhance the planarity of the external surfaces after thinning. In the following, an explanation is provided with respect to this aspect by referring to FIG. 5 and FIG. 6. FIG. 6 is a schematic diagram showing the eluate L that is uniformly sprayed from each injection hole 41 toward the external surfaces of the laminated substrate 10.

As shown in FIG. 5, each injection hole 41 is long and thin in a 45-degree slanted direction with respect to the tubular direction (perpendicular direction) of the nozzles 4. Thus, the eluate L sprayed from each injection hole 41 spreads in the shape of a cone (or a trumpet) in this slanted direction, as shown in FIG. 5.

FIG. 6 shows the eluate L that is sprayed from each injection hole 41 of a nozzle 4. On the right-hand side of FIG. 6, the spraying amount distribution of the eluate L from the injection holes 41 is observed in the height direction of the laminated substrate 10. Under the present circumstances, a point P on the external surface which faces and passes through two adjacent injection holes 41 will receive the eluate L supply from said two adjacent injection holes 41. In this case, since the point P is located at the end of the breadth of the cone-shape eluate L, as shown on the right-hand side of FIG. 6, the amount of the eluate L received from one injection hole 41 is about ½ of other points, and the two adjacent injection holes 41 are utilized to receive the eluate L supply from one injection hole 41. Accordingly, the eluate L supply for each point on the external surface is uniform in the height direction of the laminated substrate 10. Besides, the cross-section configuration of the eluate L is not limited to the shape shown in FIG. 5, it could also be the shape of an ellipse, a circle, a rectangle (a square, a rectangle), a rhombus, a parallelogram, etc.

Next, the operation of the above-mentioned device is explained.

The laminated substrate 10 after the above-mentioned sealing process is loaded on the substrate holder 3 outside of the processing chamber 2. The loading action is performed by robots or by hands of operators. Before loading on the substrate holder 3, masking by a masking tape may be performed.

The carrying means 30 operates by opening the blockade gate 23 of the carrying-in opening 21 and moving the substrate holder 3 toward the inside of the processing chamber 2. The substrate holder 3 stops when the laminated substrate 10 is located at a specific position between the nozzles 4 of both sides. Then the blockade gate 23 of the carrying-in opening 21 will be closed. In this condition, the valve 53 of the eluate supply system 5 will open, and the liquid-sending pump 54 will send the eluate L to each nozzle 4 by a predetermined pressure. Consequently, the eluate L will be sprayed from the injection holes 41 of each nozzle 4, and impact the external surfaces of the laminated substrate 10 with a specific pressure. Thus the external surfaces of the laminated substrate 10 are thinned. The eluate L eluted with the material of the laminated substrate 10 will fall and be discharged from the discharge hole 24.

After spraying the eluate L for a specific period of time, the liquid-sending pump 54 is stopped and the valve 53 is closed. Then the carrying means 30 operates so that the substrate holder 3 is moved, the blockade gate 23 of the taking-out opening 22 is opened, and the laminated substrate 10 is taken out of the processing chamber 2. The taken-out laminated substrate 10 will undergo operations such as cleaning by cleaning liquid (for example, pure water) and removal of masking tapes. Then the next partitioning process is performed.

In the operation of the above-mentioned device, the position of the laminated substrate 10 may be changed during the spraying of the eluate L, if necessary. Among all points on the external surfaces of the laminated substrate 10, when the impact pressure upon the point with a minimum distance to the injection holes 41 of all nozzles 4 becomes too high, the impact pressure upon each point after time averaging is unified by moving the laminated substrate 10 forward and backward during the spraying of the eluate L. Thus the uniformity of the external surfaces after thinning can be further enhanced. The movement of the laminated substrate 10 can also be performed upward and downward.

Moreover, in the configuration of the above-mentioned device, the liquid-sending pressure produced by the liquid-sending pump 54 is set so that the impact pressure caused by the eluate L of the external surfaces is within the range of 0.5 kg/cm²-3.5 kg/cm². In this case, the distance (“d” as shown in FIG. 3) between the injection holes 41 of the nozzles 4 and the external surfaces becomes an important factor. If the distance d is too large, the above-mentioned range of impact pressure cannot be achieved without increasing the liquid-sending pressure of the liquid-sending pump 54, which becomes difficult to practice. On the other hand, when the distance d is smaller, although it is easy to maintain the best impact pressure, the impact pressure upon the point with a minimum distance to the injection holes 41 might become too high, thereby causing a problem in the respect of uniformity. In order to ensure a practical configuration with uniformity of impact (i.e., planarity of thinning), it is preferred that the distance d is 5 mm or more and 100 mm or less. In addition, although the distance from the injection holes 41 to the external surfaces may become slightly longer during the process of thinning by the eluate L, the distance d of 5 mm or more and 100 mm or less is the distance at the time when the actual thinning process begins.

Besides, if the impact pressure is smaller than 0.5 kg/cm², the thinning process cannot be sufficiently performed since the supply of fresh eluate L is not enough, and the physical action is not sufficiently employed, thus the thinning cannot be satisfactorily performed in case that the glass constitution or the crystallized state is not uniform, which causes a problem of decreased planarity. On the other hand, if the impact pressure is larger than 3.5 kg/cm², only the points closest to the injection holes 41 of the nozzles 4 will be thinned more, which will degrade the planarity. Therefore, it is desirable to have the impact pressure within the range of 0.5 kg/cm²-3.5 kg/cm².

The so-called physical action of the impact is also employed, in addition to the chemical reaction of the eluate L, according to the above-mentioned device, thus the thinning process of high planarity can be performed; and the productivity is high due to the automation of carrying and thinning processes for the glass substrate 1.

Moreover, the injection holes 41 of the nozzles 4 are arranged with equal intervals so that the distance from each nozzle 41 to the external surface is fixed, thereby facilitating the uniformity of the impact pressure caused by the sprayed eluate L, which contributes to the improvement of planarity for the thinning process.

Moreover, the feature of eluting wherein the laminated substrate 10 is held perpendicularly is effective in facilitating the permutation of the eluate L of the external surfaces, and is technically meaningful in the sufficiently effective performing of the thinning for the external surfaces.

Furthermore, the nozzles 4 are arranged for both sides of the laminated substrate 10 so that the thinning process is performed with respect to both sides of the external surfaces concurrently, thereby contributing to higher productivity in addition to the thinning of the laminated substrate 10.

In the configuration of the above-mentioned embodiment, the thinning process of the external surfaces achieved by the eluate L can be regarded as one kind of etching. However, in addition to the chemical reaction, the incorporation of the physical action is substantially different from the process of simply dipping into an etchant or the process of simply dispersing an etchant.

Moreover, in the above-mentioned embodiment, although the thinning process of the external surfaces is performed after lamination of a pair of glass substrates 1, the thinning process of the external surfaces can sometimes be performed before the lamination. In this case, the thinning process of the external surfaces is performed before the electrodes formation process or before the color filter formation process. In this case, the substrate holder 3 is also configured to hold only one glass substrate 1. Although the mechanical strength might suffer due to the thinning of the glass substrates 1, if strong acid such as hydrofluoric acid is used, the side effect of reinforcement by the strong acid will solve said problem of thinning. Besides, the thinning process of the external surfaces can also be performed after the partitioning process. Moreover, two or more laminated substrates 10 can be held together to perform the thinning process of the external surfaces concurrently.

Although a LCD is adopted in the above-mentioned embodiment, a plasma display or an organic electroluminescence (EL) display is also applicable. Since no back light is needed for these FPD, the substrate opposite to the light-emitting side is sometimes not a glass substrate. That is, sometimes only one side of the substrates is a glass substrate. Besides, in the present invention, the effect of the present invention can also be achieved by performing the thinning process of the external surfaces with respect to one side of a pair of glass substrates.

Next, the FPD according to an embodiment of the present invention is explained.

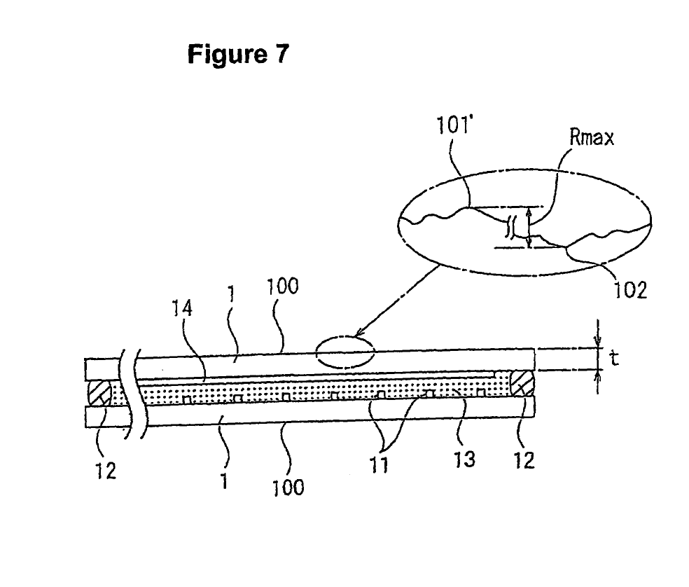

FIG. 7 is a cross-section schematic diagram of the FPD according to the embodiment. The FPD shown in FIG. 7 is formed by laminating a pair of glass substrates 1. FIG. 7 shows a liquid crystal display, which is an example of FPD, similar to the above-mentioned embodiment. Electrodes on the internal surface of one of the glass substrates 1 and the enclosed liquid crystal 13 are formed inside of the pair of glass substrates 1 as a light-transmitting control portion. A color filter 14 is formed on the internal surface of the other of glass substrates 1. The configuration of the light-transmitting control portion itself is the same as that of a normal liquid crystal display.

The FPD shown in FIG. 7 is characterized in that both external surfaces 100 of the glass substrates 1 are thinned by an external surface thinning process. The external surface thinning process is the same as that in the above-mentioned embodiments, thus the detailed description thereof is omitted. The FPD according to this embodiment is mainly characterized in that the above external surface thinning process is performed so that the external surfaces 100 have a planarity of 0.1 micrometers or less.

With regard to the planarity, as shown in FIG. 7, the distance between the highest point 101 and the lowest point 102 on the external surface 100 is referred to as a value of planarity. Such a value corresponds to a value used to measure the maximum roughness (Rmax) when measuring the surface roughness. Surface-roughness meters are commercially available from a plurality of manufacturers, the planarity of the above-mentioned external surfaces 100 can be measured by a suitable one of those meters. According to the research of the inventor of the present invention, the above-mentioned external surface thinning process is performed so that a glass substrate 1 with the thickness t of about 0.5 mm and the planarity (Rmax) of 0.1 micrometers or less is obtained, thereby providing a high-performance FPD which is thin, light and without uneven display. Besides, the planarity thereof is comparable to the planarity of the external surfaces of the glass substrates 1 prior to the external surface thinning process, thereby obtaining a result that the planarity is not degraded due to the external surface thinning process.

In the above-mentioned example, although the maximum roughness is applied, the center line average of roughness (Ra) can also be applied as the planarity. In this case, the average height of irregularities of the external surfaces 100 is derived, and then the absolute value of the difference in the height of each irregularity is derived on the basis of said height. This method is applicable since surface roughness meters which can measure the center line average of roughness (Ra) are also commercially available. Incidentally, in the case of the center line average of roughness, a FPD without display unevenness can be provided if it is 0.03 mm or less, which can also be achieved by the above-mentioned external surface thinning process.

In addition, the above-mentioned configuration is also applicable to other FPD than the liquid crystal display. In the case of organic EL displays of self-luminescence FPD, a light-emitting portion is provided in place of a light-transmitting control portion.

1. A method of manufacturing flat-panel displays, comprising: an electrodes formation process which forms electrodes on at least one of a pair of substrates, wherein one or both of said pair of substrates are glass substrates; a sealing process which laminates said pair of substrates by a sealing material to seal the interior after said electrodes formation process; and an external surface thinning process which reduces the thickness of external surfaces of the glass substrates, i.e., one or both of said pair of substrates, after said sealing process, characterized in that:
during said thinning process, an eluate which elutes material of said external surfaces of the glass substrates is sprayed toward said external surfaces with an acceleration larger than the acceleration caused by its own weight so that said eluate is sprayed toward said external surfaces and impacts said external surfaces, thereby eluting said external surfaces for thinning purpose through the physical action of the impact caused by said eluate and the chemical reaction of said eluate.

2. The method of manufacturing flat-panel displays according to claim 1, wherein said eluate is hydrofluoric acid.

3. The method of manufacturing flat-panel displays according to claim 1 or claim 2, wherein the impact on said external surfaces by said eluate is within a range of 0.5 kg/cm²-3.5 kg/cm².

4. The method of manufacturing flat-panel displays according to any one of claims 1 to 3, wherein said substrates are held so that said external surfaces are in a perpendicular incident posture during the spraying of said eluate.

5. The method of manufacturing flat-panel displays according to any one of claims 1 to 4, wherein the external surfaces of both of said pair of substrates after said lamination are thinned concurrently so that the whole thickness is reduced.

6. The method of manufacturing flat-panel displays according to any one of claims 1 to 5, wherein said eluate is sprayed through injection holes of nozzles, and the distances from the injection holes of the nozzles at the beginning of the thinning to said external surfaces of the substrates are within a range of 5 mm to 100 mm.

7. The method of manufacturing flat-panel displays according to any one of claims 1 to 5, wherein said eluate is sprayed through injection holes of nozzles, said injection holes are arranged with equal intervals, and the distance from each of said injection holes to said external surfaces is fixed.

8. A surface thinning device for thinning external surfaces of glass substrates of flat-panel displays, characterized by comprising:
a processing chamber in which the thinning of external surfaces is processed;
a substrate holder for holding said glass substrates to a predetermined location in said processing chamber;
nozzles having injection holes for spraying an eluate toward said external surfaces of the glass substrates held by said substrate holder; and
an eluate supply system for supplying the eluate to the nozzles,
said eluate supply system supplies the eluate to the nozzles so that the eluate is sprayed toward and impacts said external surfaces with an acceleration larger than the acceleration caused by its own weight, thereby eluting said external surfaces for thinning purpose through the physical action of the impact caused by said eluate and the chemical reaction of said eluate.

9. The surface thinning device according to claim 8, wherein said eluate is hydrofluoric acid.

10. The surface thinning device according to claim 8 or claim 9, wherein said eluate supply system forces said eluate to be sprayed from said injection holes of said nozzles to impact said external surfaces of said glass substrates with a pressure within a range of 0.5 kg/cm²-3.5 kg/cm².

11. The surface thinning device according to any one of claims 8 to 10, wherein said substrate holder holds said substrates so that said external surfaces are in a perpendicular incident posture during the spraying of said eluate.

12. The surface thinning device according to any one of claims 8 to 11, wherein said nozzles are arranged for both of said pair of glass substrates held by said substrate holder so that the external surfaces of both of said pair of glass substrates after said lamination are thinned concurrently.

13. The surface thinning device according to any one of claims 8 to 12, wherein the distances from said injection holes of said nozzles at the beginning of the thinning to said external surfaces of said glass substrates are within a range of 5 mm to 100 mm.

14. The surface thinning device according to any one of claims 8 to 13, wherein said injection holes are arranged with equal intervals, and the distance from each of said injection holes to said external surfaces is fixed.

15. A flat-panel display formed with a light-transmitting control portion or light-emitting portion inside a pair of glass substrates after lamination, characterized in that:
an eluate is sprayed toward both external surfaces of said pair of glass substrates with an acceleration larger than the acceleration caused by its own weight so that said eluate performs thinning operation by a way of spraying and impacting, and obtains a planarity where its maximum roughness is 0.1 μm or less.
